(19) United States
(12) Patent Application Publication
(10) Pub. No.: US 2002/0051047 A1
(43) Pub. Date: May 2, 2002

(54) Recording medium, image-forming method using the same and method of manufacturing such recording medium

(76) Inventors: Masanobu Asaoka, Kanagawa (JP); Katsutoshi Misuda, Kanagawa (JP)

Correspondence Address: FITZPATRICK CELLA HARPER & SCINTO, 30 ROCKEFELLER PLAZA, NEW YORK, NY, 10112, US

(21) Appl. No.: 09/944,071

(22) Filed: Sep. 4, 2001

(30) Foreign Application Priority Data
Sep. 7, 2000 (JP) 272052/2000

(51) Int. Cl. B41J 3/407

(52) U.S. Cl. 347/106

(57) ABSTRACT

A recording medium comprising a base material and an ink-receiving layer provided on the base material and containing a particulate material, the particulate material containing particles of crystalline aluminum oxide, the ink-receiving layer being obtained by applying a coating solution containing the particulate material to the base material followed by drying to form a coating layer, applying water to the coating layer to cause swelling and pressing the surface thereof against a heated mirror-surface drum to conduct drying treatment, wherein the specular gloss of the surface of the ink-receiving layer is not less than 20% as measured at 20°.

### BACKGROUND OF THE INVENTION

1. Field of the Invention

This invention relates to a recording medium suitable for forming a print (printed image) comparable to images produced by silver salt photography in terms of texture and image quality by means of an ink-jet recording system for applying droplets of recording liquid such as ink and also to an image-forming method adapted to use such a recording medium.

2. Related Background Art

Ink-jet recording systems are designed to cause micro-droplets of a recording liquid such as ink to fly and eventually adhere to a recording medium such as a sheet of paper in order to record an image that may be an image of a character on the recording medium. A variety of operational principles have been proposed to date for ink-jet recording systems. The ink-jet recording system is advantageous in terms of high speed operation, low noise emission, capability of multi-color printing, versatility for producing recording patterns and needlessness of developing process. Therefore, ink-jet recording systems have become increasingly popular and are currently used not only for the output units of stand-alone printers but also for those of copying machines, word processors, fax machines, plotters and other information devices. Additionally, as a result of the commercial availability of low cost and high performance digital cameras, digital video recording machines, scanners and other similar devices and the popular use of personal computers in recent years, printers combined with an ink-jet recording system have been widely used as output units for outputting image information from such devices.

With the above described background, there is a strong demand for outputting multi-color images comparable to those obtained by silver salt photography or gravure printing in an easy ways by means of an ink-jet recording system.

Efforts have been made to meet the demand by providing ink-jet printers that are improved in terms of high speed recording, high definition recording and full-color recording, improved recording methods and/or recording media that are improved in terms of structure and performance.

Various recording media have been proposed to date in the field of ink-jet recording. For instance, Japanese Patent Application Laid-Open No. 52-9077 describes a recording medium comprising an ink-receiving layer mainly made of particles of silica-based pigment having a large specific surface area and containing voids therein in order to improve the ink absorbing rate of the recording medium. Japanese Patent Application Laid-Open No. 63-22997 discloses a recording medium in which the voids of the pigment layer which forms an ink-receiving layer are regulated. Japanese Patent Application Laid-Open Nos. 55-51583 and 56-157 describe techniques of adding non-crystalline silica powder in order to improve the ink absorptivity of the ink-receiving layer and obtain high print density and printed dots that are free from bleeding.

Alumina hydrate has been attracting attention as a material that can be used for the ink-receiving part of a recording medium. U.S. Pat. Nos. 4,879,166 and 5,104,730 and Japanese Patent Application Laid-Open Nos. 2-276670, 4-37576 and 5-32037 describe respective recording media having a layer containing alumina hydrate with a pseudo-boehmite structure as an ink-receiving layer. Japanese Patent Application Laid-Open No. 10-94754 discloses a recording medium comprising a layer containing alumina hydrate formed by casting in order to realize both a high ink absorptivity and a high gloss.

Additionally, Japanese Patent Application Laid-Open No. 11-1060 describes a recording medium comprising an ink-receiving layer formed by sequentially providing a porous layer containing barium sulfate and a layer containing non-oriented alumina hydrate in order to increase the ink absorbing rate and prevent the generation of beadings. The recording medium proposed in the above patent document provides an excellent printing quality.

On the other hand, Japanese Patent Application Laid-Open Nos. 7-117335, 8-118790 and 9-99628 disclose respective recording media comprising an ink-receiving layer containing silica as a principal ingredient and formed by utilizing cast-coating and a gloss producing layer arranged on the ink-receiving layer.

On the other hand, Japanese Patent Application Laid-Open No. 10-129112 describes a sheet for ink-jet in which an ink-receiving layer using fine aluminum oxide particles of the γ-crystal structure having an average particle diameter of at most 200 nm is formed on a base material of a synthetic resin sheet.

The inventors of the present invention have paid intensive efforts in an attempt for obtaining a recording medium having a recording performance comparable to those of the above cited prior art by using particles of crystalline aluminum oxide in order to improve the surface strength of the ink-receiving layer that normally contains alumina hydrate with a pseudo-boehmite structure. To date, any recording medium comprising a layer containing particles of crystalline aluminum oxide can produce only poorly glossy images. While the surface gloss of the ink-receiving layer containing aluminum oxide of a recording medium may be improved to a certain extent when the layer is subjected to a process for physically smoothing the surface typically by means of a super-calender the ink absorptivity of the layer can become degraded by the process. This is the reason why the use of aluminum oxide has attracted less attention than that of alumina hydrate with a pseudo-boehmite structure for the ink-receiving layer of a recording medium for ink-jet recording.

Recording media obtained by means of a method using cast-coating as disclosed in Japanese Patent Application Laid-Open Nos. 7-117335, 8-118790 and 9-99628 are not satisfactory for producing a printed image comparable to images obtained by silver salt photography in terms of gloss, texture and image quality by means of an ink-jet recording system.

### SUMMARY OF THE INVENTION

In view of the above identified circumstances, it is therefore an object of the present invention to provide a recording medium to be suitably used for an image-forming method that may utilize an ink-jet recording system to apply a recording liquid to the recording medium and produce a print (printed image) thereon that is comparable to those obtained by silver salt photography in terms of texture and image quality and also to an image-forming method adapted to use such a recording medium.

Another object of the present invention is to provide a recording medium comprising an ink-receiving layer formed mainly from crystalline aluminum oxide that is to be suitably used for an image-forming method that may utilize an ink-jet recording system to apply a recording liquid to the recording medium and produce a print (printed image) thereon that is comparable to those obtained by silver salt photography in terms of texture and image quality and also to an image-forming method adapted to use such a recording medium.

In an aspect of the invention, the above objects and other objects of the present invention are achieved by providing a recording medium comprising a base material and an ink-receiving layer provided on the base material and containing a particulate material;

the particulate material containing particles of crystalline aluminum oxide;

the ink-receiving layer being obtained by applying a coating solution containing the particulate material to the base material followed by drying to form a coating layer, applying water to the coating layer to cause swelling and pressing the surface thereof against a heated mirror-surface drum to conduct drying treatment;

wherein the specular gloss of the surface of the ink-receiving layer is not less than 20% as measured at 20°.

In another mode of the recording medium of the invention, the above described recording medium further comprises:

an alumina-containing layer provided on the surface of the base material opposite to the surface onto which the ink-receiving layer is provided.

In another aspect of the invention, there is provided a method of manufacturing a recording medium comprising a base material and an ink-receiving layer provided on the base material and containing a particulate material, comprising:

producing a coating layer by applying a coating solution containing the particulate material containing particles of crystalline aluminum oxide to the base material followed by drying;

applying water to the coating layer to cause swelling and pressing the surface of the swelled coating layer against a heated mirror-surface drum to produce the ink-receiving so as to have a specular gloss of the surface thereof not less than 20% as measured at 20°.

Preferably, the base material of a recording medium according to the invention comprises a surface layer containing barium sulfate and has a low penetrability and a high density.

In still another aspect the invention, there is provided an image-forming method in which an image is formed by applying a recording liquid to the surface of the ink-receiving layer of a recording medium according to the invention in compliance with the recording information. Preferably, an ink-jet recording system is used for applying the recording liquid.

According to the invention, a considerably high gloss of not less than 20% can be obtained on the image-forming surface of a recording medium as measured at 20°. Therefore, the texture and the quality of the image formed on a recording medium according to the invention are comparable to those of any image obtained by silver salt photography. Accordingly, an image that is comparable to or excels any image obtained by silver salt photography in terms of texture and image quality can be printed by means of a process that is by far more simple and of higher speed than the silver salt photography process when a recording medium according to the invention is combined with an ink-jet recording system for an output system.

### DETAILED DESCRIPTION OF THE PREFERRED EMBODIMENTS

A recording medium according to the invention comprises a base material and an ink-receiving layer provided on the base material, wherein the side of the ink-receiving layer of the recording medium serves as a recording surface. The ink-receiving layer is a porous layer containing crystalline aluminum oxide particles as a principal ingredient. A recording liquid supplied to the recording medium from a recording apparatus is absorbed by the ink-receiving layer.

The base material for forming thereon the ink-receiving layer is typically formed from a fibrous substrate containing wood pulp and a filler such as appropriately sized paper or non-sized paper. Preferably, the base material comprises a fibrous substrate and a surface layer formed by applying an inorganic pigment containing barium sulfate onto the fibrous substrate along with a binder in order to make the recording medium having a high gloss.

For the purpose of the invention, the fibrous substrate weighs preferably not less than 120 g/m², more preferably between 150 and 180 g/m² and has a Stoeckgt sizing degree of preferably not less than 100 seconds, more preferably not less than 200 seconds. A high quality recording medium of the A4 or A3 size can be obtained by using such a fibrous substrate.

The surface layer containing barium sulfate and formed on the fibrous substrate is typically formed by mainly using barium sulfate and a binder. Since barium sulfate is used to give whiteness and light resistance to the surface of the fibrous substrate, the impurities contained in it should be removed to the most possible extent. Preferably, barium sulfate has an average particle size that is optimally effective for improving the smoothness, the gloss and the solvent absorptivity of the surface of the layer. For the purpose of the invention, the average particle size of the barium sulfate of the surface layer is preferably between 0.4 μm and 1.0 μm, more preferably between 0.4 μm and 0.8 μm. The excellence of the recording medium is improved in terms of whiteness, gloss and solvent absorptivity when the average size is found within the above range.

The image quality comparable to that of an image obtained by silver salt photography is obtained because of the fact that the surface layer that contains barium sulfate is highly white and has a high refractive index to give a high reflectivity and that a highly transparent ink-receiving layer is formed on the surface layer. The smoothness of the surface of the fibrous substrate is improved as a result of the formation of the surface layer that contains barium sulfate. The provision of the surface layer is highly effective for improving the surface gloss of the recording medium particularly when the surface of the base material has minute undulations on the surface. Barium sulfate may be replaced by some other substance that meets the above identified requirements.

The use of such dense and fibrous base material comprising a layer containing barium sulfate prevents drop landing off-target caused by swelling of the base material that absorbed ink in a printing operation and can form images without losing gloss obtained as a result of a casting process. If the fibrous substrate swells in the step of applying water to the produced ink-receiving layer to make it re-swell in the course of manufacturing the recording medium, the surface of the recording medium may not be satisfactorily smoothed when it is pressed against a heated drum. However, the use of a base material comprising a layer containing barium sulfate can effectively prevent such a problem and gives a high gloss to the surface of the recording medium.

For the purpose of the invention, any binder can be used for binding the applied barium sulfate so long as it is made of a polymer having a high binding effect. Examples of binders that can be used for the purpose of the invention include polyvinyl alcohol, vinyl acetate, oxidized starch, etherified starch, casein, gelatin, protein of soy beans, styrene-butadiene type latex, polyvinylacetate, polyacrylates, polyesters, polyurethanes and other appropriate synthetic polymers. Any of these binders can be used alone or in combination depending on the application. The compounding ratio of barium sulfate to the binder by weight is preferably between 10:0.7 and 10:10, more preferably between 10:1 and 10:5.

Of the above cited binders, gelatin may most suitably be used for the purpose of the invention because the refractive index of barium sulfate and that of gelatin is close to each other and therefore gelatin can effectively reduce the reflection along the interface thereof and accordingly raise the gloss at 20° of the recording medium. Any type of gelatin processed either by acid or alkali may be used for the purpose of the invention. When gelatin is used in combination with barium sulfate to form a so-called baryta layer, preferably 100 parts by weight of barium sulfate are compounded with 6 to 12 parts by weight of gelatin by weight. If necessary, a cross-linking agent to be used for gelatin such as chromium sulfate, chrome alum, formalin or triazine may be added to the mixture. The cross-linking agent is added preferably to a compounding ratio of between 0.2 to 4 parts by weight base on 100 parts by weight of gelatin. Chrome alum is preferably used as a cross-linking agent because it can be handled with ease.

The surface layer containing barium sulfate can be formed by applying a coating solution prepared by dispersing barium sulfate into an appropriate solvent such as water, if necessary, with a binder added thereto to the surface of the substrate where the surface layer is to be formed and then drying the solution.

The surface layer containing barium sulfate is formed preferably at a coating amount of between 10 and 40 g/m² in order to make the surface layer reliably absorb the solvent of ink and show a satisfactory level of surface smoothness. While any appropriate application/drying method may be used for forming the surface layer containing barium sulfate, the formed surface layer is preferably subjected to a finishing process such as a super calender process in order to smooth the surface of the surface layer.

If necessary, the components of the surface layer containing barium sulfate may be prevented from being eluted during the process of forming the ink-receiving layer by subjecting it to a combination of a heat treatment and the use of a thermosetting resin, an acetalifying process and/or a chemical reaction involving a film hardening agent. When forming an ink-receiving layer on the surface layer containing barium sulfate, the coating solution for forming the ink-receiving layer can become whitely opaque if some of the components of the surface layer containing barium sulfate is eluted. Then, the ink-receiving layer can partly lose its transparency and become less apt to dry during the process of forming the ink-receiving layer to consequently reduce the surface smoothness and give rise to cracks and other defects. Therefore, the above described process for preventing possible elution of any of the components of the surface layer is preferably used for the purpose of the invention.

If desirable, a dispersant, a tackifier, a pH regulator, a lubricant, a fluidizer, a modifier, a surfactant, a defoamer, a water-resistance imparting agent, a parting agent, a fluorescent whitening agent, an ultraviolet absorbent and/or an anti-oxidant may also be added to the coating solution to such an extent that the effect of the present invention may not be impaired by the addition.

When a base material comprising a surface layer containing barium sulfate is used, both the whiteness and the smoothness of the recording medium may depends on the surface layer to a large extent. Therefore, preferably, the whiteness and the Bekk smoothness of the surface layer containing barium sulfate are respectively not less than 87% and not less than 400 seconds at the side bearing the ink-receiving layer of the finished recording medium. On the other hand, the Bekk smoothness at the surface of the finished recording medium is preferably not more than 600 seconds, more preferably not more than 500 seconds, because the effect of absorbing the solvent of the recording liquid can be reduced when the smoothness is too high.

The base material of a recording medium according to the invention preferably has a low gas penetrability. If the base material has a high gas penetrability, the fibers of the base material will not be dense and it can easily absorb ink and swell to produce undulations on the surface. Then, the recording medium may not show a texture comparable to that of a silver salt photograph. On the other hand, aluminum oxide that is used for forming the ink-receiving layer on the base material is required to give the ink-receiving layer which

(1) absorbs ink at an enhanced rate;

(2) provides a high print density and a high coloring effect to the image printed there; and

(3) has an excellent weather-proofness in addition to the required degree of gloss.

For the purpose of the present invention, crystalline aluminum oxide particles are prepared by a method referred to as the Bayer's process, with which aluminum hydroxide obtained by processing bauxite, a natural mineral, by means of hot caustic soda is baked to produce aluminum oxide. However, some other method such as the one with which pellets of metal aluminum are caused to produce spark discharges in water and the obtained aluminum oxide is baked or the one with which an inorganic aluminum salt (e. g., alum) is decomposed may alternatively be used for the purpose of the invention.

As for the crystal structure of aluminum oxide particles, it is known that aluminum oxide having the γ, σ, η, θ or α-crystal structure can be obtained from gibbsite type or boehmite type aluminum hydroxide by heat treatment depending on the temperature of heat treatment. Aluminum oxide particles having any of the above listed crystal structures and/or prepared by any of the above listed methods may be used for the purpose of the invention.

The average diameter of aluminum oxide particles to be used for the purpose of the invention is preferably not more than 1 μm, more preferably not more than 0.3 μm, and not less than 80% of all the aluminum oxide particles in the ink-receiving layer preferably has a diameter of not more than 1 μm (The percentage of the aluminum oxide particles having a diameter of not more than 1 μm based on the total aluminum oxide particles is not less than 80%). When aluminum oxide particles with a diameter greater than 1 μm occupy more than 20% of all the particles, the re-swelling effect of the ink-receiving layer and the surface smoothing efficiency of the operation of pressing the ink-receiving layer to a hot drum can be reduced as a function of the percentage of such large particles in the process of applying water to re-swell the ink-receiving layer, so that the recording medium may not show a satisfactory gloss.

For the purpose of the present invention, the BET specific surface area of aluminum oxide is preferably between 70 and 300 m²/g, more preferably between 100 and 160 m²/g. If the BET specific surface area of aluminum oxide is found below the above range, the pore size distribution is shifted to the larger particles so that the ink-receiving layer of the recording medium can no longer satisfactorily adsorb the dyes contained in the ink applied to it, and the pores in the aluminum oxide particles give rise to irregular reflection of light in the inside to adversely affect the color density. If, on the other hand, the BET specific surface area of aluminum oxide is found above the above range, the ink-receiving layer no longer allows ink to be applied thereto with particles of aluminum oxide held in a well dispersed state so that the pore size distribution can no longer be regulated to provide the ink-receiving layer with a satisfactory level of ink absorptivity and surface gloss.

For the purpose of the invention, aluminum oxide is required to provide the ink-receiving layer with a desired level of transparency and gloss and the fixability of the colorant such as a dye contained in the recording solution applied to it. Furthermore, aluminum oxide is also required not to give rise to any defects such as cracks in the ink-receiving layer in the process of forming the latter and to allow the coating solution for forming the ink-receiving layer to be applied smoothly.

For the purpose of the present invention, aluminum oxide particles preferably has a plate-like profile with an average aspect ratio of between 1 and 4. Fibrous aluminum oxide particles with a large aspect ratio are apt to be oriented in a direction parallel to the surface of the base material during the coating process. On the other hand, plate-like aluminum oxide particles are less apt to be oriented during the coating process and hence the pores of the produced ink-receiving layer have a relatively large volume. For the purpose of the present invention, the average aspect ratio refers to the value obtained by dividing the long axis of the particles in the ink-receiving layer by the short axis. When aluminum oxide is in the form of spherical particles as in the case of colloidal silica, the particles of the ink-receiving layer are apt to be so arranged as to substantially take closest packing.

According to the invention, a coating solution containing particles of aluminum oxide is applied to the surface of a base material to produce a coating layer that eventually makes an ink-receiving layer and the produced coating layer is made to re-swell by means of water. Then, the surface of the coating layer is pressed against a heated mirror-surface drum to dry the coating layer to produce an ink-receiving layer. It is desirable to use small plate-shaped aluminum oxide particles that are poorly apt to be oriented in order to provide the ink-receiving layer with an intended degree of gloss. When the coating layer shows a structure where partially oriented crystals of plate-shaped aluminum oxide particles are randomly agglomerated, water can quickly penetrate into the gaps of the randomly agglomerated structure to make the coating layer swell easily and rearrange the crystals in the re-swelling process if water is applied only at a limited amount. Then, the surface of the coating layer can be smoothed effectively when the surface thereof is pressed against a heated mirror-surface drum and dried. At the same time, since the surface of the coating layer swells effectively with a small amount of water applied thereto, steam can escape from the rear surface of the base material only at a low rate in the pressing/drying process so that a dense and very flat base material can be used for the purpose of the invention. For the above reasons, according to the invention, it is possible to provide a glossy recording medium comprising an ink-receiving layer that scatters light at the surface only to a small extent. Additionally, the ink-receiving layer absorbs ink excellently because the aluminum oxide particles are randomly oriented and hence the pores of the coating layer are hardly crushed during the pressing process.

If, to the contrary, fibrous particles having a large aspect ratio are used, they are oriented not randomly but in parallel so that the coating layer would not swell and crystal rearrangement would not occur easily when water is applied to the surface thereof. Therefore, the surface would not be smoothed effectively when it is pressed against a heated mirror-surface drum for drying. While the coating layer may swell to some extent if a large amount of water is applied to the surface, the base material will not dry satisfactorily particularly when it is dense, because the generated large amount of steam that has to be allowed to escape from the rear surface thereof cannot go anywhere. Anyway, the ink-receiving layer would not show a desired degree of gloss. Additionally, since the particles of aluminum oxide are oriented in parallel, pores are formed only scarcely in the ink-receiving layer and will be lost easily during the pressing process to make the layer poorly ink-absorptive, if compared with an ink-receiving layer containing plate-shaped crystals.

If the particles of aluminum oxide have a spherical profile, the particles of the ink-receiving layer are apt to be so arranged as to substantially take the closest packing as described above. Then, the coating layer would not swell significantly when water is applied to the surface thereof so that the surface would not be glossed any further by the pressing/drying process. Additionally, since the coating layer does not swell, the ink-absorbing effect of the ink-receiving layer is less remarkable if compared with an ink-receiving layer containing plate-shaped crystals.

Therefore, the ink-receiving layer of a recording medium according to invention provides a remarkable effect only when aluminum oxide particles having a specific profile are used.

For the purpose of the invention, if necessary, a binder may be used for forming the ink-receiving layer on a recording medium according to the invention. Binders that can suitably be used for the purpose of the invention include water-soluble polymers. Examples of polymers that can be used for the purpose of the invention include polyvinyl alcohol, modified polyvinyl alcohol, starch, modified starch, gelatin, modified gelatin, casein, modified casein, gum arabic, cellulose derivatives such as carboxymethylcellulose, hydroxyethylcellulose and hydroxypropylmethylcellulose, conjugated diene type polymer latex such as SBR latex, NBR latex and methylmethacrylate-butadiene copolymer, functional-group-modified polymeric latex, vinyl type copolymer latex such as ethylene vinyl acetate copolymer, polyvinylpyrrolidone, maleic anhydride and its copolymers and acrylate copolymers. Any of these binders may be used alone or in combination.

The mixing ratio of particulate aluminum oxide to the binder is preferably between 1:1 and 10:1, more preferably between 5:1 and 25:1, by weight. When the amount of the binder lies within this range, the ink-receiving layer shows a high mechanical strength and is prevented from producing cracks and powdery exfoliation during the process of forming the layer to maintain an appropriate pore volume in the inside.

If necessary, the particulate material of the ink-receiving layer may contain any known particulate inorganic or organic pigment in addition to particulate aluminum oxide. However, the content of the additional components needs to be minimized because the added components can adversely affect the transparency, the porosity and the random orientation of the particles of aluminum oxide in the ink-receiving layer. For the purpose of the invention, the particulate material of the ink-receiving layer contains particulate aluminum oxide preferably by not less than 70 wt %, more preferably by not less than 90 wt %.

On the other hand, if necessary, the coating solution for forming the ink-receiving layer according to the invention may contain, in addition to particulate aluminum oxide and a binder, a dispersant, a tackifier, a pH regulator, a lubricant, a fluidizer, a modifier, a surfactant, a defoamer, a water-resistance imparting agent, a releasing agent, a fluorescent whitening agent, an ultraviolet absorbent and/or an anti-oxidant to such an extent that the effect of the present invention may not be impaired by the addition of such additives.

For manufacturing a recording medium comprising an ink-receiving layer according to the invention, the coating solution containing particles of aluminum oxide in a dispersed state may be applied to the base material and dried by means of a coating device. Any appropriate application method may be used for the purpose of the invention. Coating devices that can be used for the purpose of the invention include a blade coater, an air knife coater, a roller coater, a curtain coater, a bar coater, a gravure coater, a die coater and a sprayer. The coating solution containing aluminum oxide for forming the ink-receiving layer is applied at a coating amount preferably not more than 30 g/m², more preferably between 20 and 30 g/m², in terms of dry solid matter from the viewpoint of good fixing of the colorants such as a dye contained in the recording liquid and good smoothness of the surface of the ink-receiving layer. If necessary, the produced ink-receiving layer may be subjected to a baking process.

A casting process in which the surface of the ink-receiving layer is pressed against a heated mirror-surface drum while the ink-receiving layer is in a swollen state followed by drying is preferably used to gloss the surface of the ink-receiving layer. More specifically, according to the invention, a coating solution for forming an ink-receiving layer is applied to the surface of a base material and then dried by a known technique, and subsequently the produced coating layer that eventually makes an ink-receiving layer is treated typically by means of hot water to bring it back into a swollen state. Thereafter, the surface of the swollen coating layer is pressed against a heated mirror-surface drum and dried to produce the ink-receiving layer. As a result of pressing the surface of the swollen coating layer against a heated drum, the ink-receiving layer is made highly glossy at the surface, while maintaining the porous structure. Additionally, according to the invention, the swollen coating layer is dried and made to swell again before the surface of the swollen coating layer is pressed against a heated mirror-surface drum and dried, so that steam escapes from the rear surface of the base material only at a small rate during the process of pressing the surface of the layer against a heated drum. Thus, any base material may be used for the purpose of the present invention only with few limitations. For instance, an ink-receiving layer formed on a dense base material can be made very glossy.

The gloss of the surface of the ink-receiving layer of a recording medium according to the invention obtained in the above described manner is so regulated as to be not less than 20% as measured at 20°. For the purpose of the invention, the gloss is measured by a method conforming to JIS-Z-8741. Conventionally, the gloss of the surface of a recording medium is measured at 60°. However, if the surface shows a satisfactory level of gloss as measured at 60°, it may need to be further improved in terms of texture and gloss comparable to those of silver salt photography. This is because the surface of the recording medium does not provide a satisfactory level of gloss at an angle with which the viewer actually sees the image printed on it. According to a study of the inventors of the present invention, the gloss measured at 20° is vitally important from the viewpoint of providing a high level of gloss and texture comparable to that of silver salt photography. A recording medium according to the invention and prepared in the above described manner can provide a high level of gloss and texture comparable to that of silver salt photography that cannot be achieved by any known recording medium of the type under consideration, because the surface of the ink-receiving layer is not less than 20% as measured at 20°.

Additionally, a recording medium according to the invention shows an excellent color reproducibility because the particles of aluminum oxide is electrically positively charged to strongly adsorb the dye of ink. Still additionally, the ink-receiving layer thereof absorbs ink quite well. As a result, a recording medium according to the invention can provide an image that is comparable to a silver salt photograph in terms of texture and image quality. The ink-receiving layer of a recording medium according to the invention is particularly free from scattered light when a fibrous base material weighing not less than 120 g/m², having a Stoeckgt sizing degree of not less than 100 seconds and having a layer containing barium sulfate is used, providing the best mode of the recording medium of the invention.

Furthermore, since the ink-receiving layer of a recording medium according to the invention is highly glossy but at the same time porous, the blocking phenomenon can hardly appear even when the ink-receiving layers of a pair of sheets of recording medium according to the invention are laid one on the other. Additionally, a finger print would not be formed on the ink-receiving layer of a recording medium according to the invention if a finger tip is placed on the layer. Thus, a recording medium according to the invention is highly advantageous from the viewpoint of handling and storage.

A recording medium according to the invention may be provided on the rear surface of the base material (the surface opposite to the surface of the ink-receiving layer) with a back coat layer for preventing the recording medium from curling in a recording process. The back coat layer is designed to prevent the recording medium from curling in a recording process because of the difference in shrinkage caused by moisture between the base material and the ink-receiving layer. Therefore, the back coat layer preferably shows the same change (shrinkage) as the ink-receiving layer at the front side of the base material when the recording medium absorbs moisture. The back coat layer may be made to contain alumina. Alumina that can be used for the back coat layer may be alumina hydrate such as boehmite or pseudo-boehmite or crystalline aluminum oxide such as γ-alumina or θ-alumina, although it is not limited thereto.

If necessary, a binder may be used for forming the back coat layer. Examples of binders that can be suitably used with alumina include water-soluble polymers such as polyvinyl alcohol, modified polyvinyl alcohol, starch, modified starch, gelatin, modified gelatin, casein, modified casein, Arabic rubber, cellulose derivatives such as carboxymethylcellulose, hydroxyethylcellulose and hydroxypropylmethylcellulose, conjugated diene type polymer latex such as SBR latex, NBR latex and methylmethacrylate-butadiene copolymer, functional-group-modified polymer latex, vinyl type copolymer latex such as ethylene vinyl acetate copolymer, polyvinylpyrrolidone, maleic anhydride and its copolymers and acrylate copolymers. Any of these binders may be used alone or in combination.

The curl preventing effect and the mechanical strength of the back coat layer can be optimized when the mixing ratio of alumina to the binder of the back coat layer is preferably between 1:1 and 10:1, more preferably between 5:1 and 25:1 by weight. If necessary, a dispersant, a tackifier, a pH regulator, a lubricant, a fluidizer, a surfactant, a defoamer, a water-resistance imparting agent, a releasing agent, a fluorescent whitening agent, an ultraviolet absorbent and/or an anti-oxidant may also be added to the back coat layer to such an extent that the effect of the present invention may not be impaired by the addition.

Any of the above described methods for applying the coating solution containing particles of aluminum oxide in a dispersed state to the base material and drying it may also be used for forming the back coat layer on the other side of the recording medium. Coating devices that can be used for the purpose of the invention include a blade coater, an air knife coater, a roller coater, a curtain coater, a bar coater, a gravure coater, a die coater and a sprayer. The coating solution containing alumina for forming the back coat layer is applied at a coating amount preferably between 5 and 25 g/m², more preferably between 10 and 20 g/m², in terms of dry solid matter. If necessary, the produced ink-receiving layer may be subjected to a baking process. By providing the recording medium with a back coat layer, the problem of possible appearance of the curling phenomenon at the time of a recording operation can be reliably avoided. The back coat layer containing alumina allows the user to comfortably write letters there by means of a pencil, a fountain pen, a ball point pen, a felt pen or the like. It is also possible to make the rear surface of the recording medium adapted to ink-jet recording.

Any known water type ink can be used for forming an image on a recording medium according to the invention. However, for the purpose of the present invention, an ink containing an anionic compound such as a water-soluble dye having at least an anionic group in a molecule is preferably used. Water-soluble dyes that can be used for the purpose of the invention include direct dyes, acidic dyes and reactive dyes having an anionic group such as a sulfonic group or a carboxyl group in a molecule. Such a water-soluble dye is normally used in an amount of 0.1 to 20 wt % in conventional ink and the above cited range is also applicable to the present invention. Water or a mixture solvent containing water and a water-soluble organic solvent is preferably used with the water-soluble ink for the purpose of the present invention. Particularly, the use of a mixture solvent containing water and a water-soluble organic solvent is preferable for the purpose of the invention. More particularly, a mixture containing water and polyhydric alcohol as a water-soluble organic solvent can effectively prevent the ink from drying.

An ink-jet recording method selected from known methods including the one using a piezoelectric element and the one using a heat-generating element may suitably be used for forming an image by ink-jet recording according to the invention.

(Embodiments)

Now, the present invention will be described further by way of examples.

### Manufacturing Example 1

Aluminum octaxide was synthetically formed by using a method described in U.S. Pat. Nos. 4,242,271 and 4,202,870 and the product was subsequently hydrolyzed to obtain alumina slurry. Thereafter, the obtained alumina slurry was dried to obtain powdery pseudo-beohmite, which was then baked at 500° C. for 2 hours in an oven to produce particulate aluminum oxide having a γ-type crystal structure (to be referred to as γ-alumina hereinafter). The median value of the distributed particle sizes was 20 μm. The obtained γ-alumina was dispersed in pure water to make it show a concentration of 20 wt % by using acetic acid as a dispersant and subsequently treated in a ball mill for 40 hours. Thereafter, large particles were removed by means of centrifugal separation to obtain treated γ-alumina with an average particle diameter of 0.25 μm. The particle at lower 80% of the particle size distribution showed an particle diameter of 0.76 μm.

For the purpose of observing the gloss of the recording medium containing treated γ-alumina as a principal ingredient, the treated γ-alumina and a polyvinyl alcohol solution (PVA-117: tradename, available from Kuraray) was mixed at a mixing ratio by weight of 10:1 in terms of the ratio of the solid matter content of the treated γ-alumina to that of polyvinyl alcohol, and the mixture was stirred well to obtain dispersed solution 1.

The dispersed solution 1 was applied to a base material having a surface layer containing barium sulfate (with a Bekk smoothness of 420 seconds and a whiteness degree of 89%) by means of a dye coating method at a coating amount of 30 g/m² as determined after drying and then the applied solution was dried. The base material had been prepared by applying a baryta composition containing 100 parts by weight of barium sulfate and 10 parts by weight of gelatin onto a fibrous substrate weighing 150 g/m² and having a Stoeckgt sizing degree 200 seconds to form a surface layer and subsequently calendaring the surface layer. Thus, the recording medium 1 comprising the base material having the surface layer and the ink-receiving layer was prepared.

### EXAMPLE 1

Hot water (80° C.) was applied to the surface of the ink-receiving layer of the recording medium 1 obtained in Manufacturing Example 1 by means of a rewetting cast coater to make the ink-receiving layer swell and then the recording medium 1 was subjected to a rewetting cast treatment to produce recording medium 2.

### EXAMPLE 2

AKP-G015 (tradename, available from Sumitomo Chemical Industries) was used as a starting material for particulate aluminum oxide. More specifically, AKP-G015 used as a starting material was γ-alumina with a median value of 2.4 μm in the particle size distribution. This starting material was subjected to the same treatment process as that of Example 1 to produce treated γ-alumina. The average particle diameter of the particle size distribution was 0.24 μm. The particle at lower 80% of the particle size distribution showed an particle diameter of 0.49 μm. An ink-receiving layer was formed on the surface layer as in Example 1 except that the treated γ-alumina obtained in this example was used. Then, recording medium 3 was prepared by means of the same rewetting cast treatment as the one described above for Example 1.

The gloss of each of the specimens of recording medium obtained in Manufacturing Example 1 and Examples 1 and 2 was observed according to JIS-Z-8741, using a digital variable angle gloss meter (available from Suga Test Instruments). Table 1 below summarily shows the obtained results. A photographic image was printed on the glossy surface of the ink-receiving layer of each of the specimens of recording medium by means of an ink-jet printer (BJF-8500: tradename, available from Canon) according to the image information applied thereto to find that the printed image was comparable to a silver salt photograph in terms of both texture and image quality.

TABLE 1

| Recording medium | | gloss at 20° |
|---|---|---|
| Manufacturing Example 1 | 1 | 12.0% |
| Example 1 | 2 | 31.0% |
| Example 2 | 3 | 29.0% |

### EXAMPLE 3

An aqueous dispersed solution containing polyvinyl alcohol (PVA117: tradename, available from Kuraray) and γ-alumina (average particle diameter of 1.5 μm) with their respective weight ratio of 15:100 in terms of solid matter was prepared. The overall solid matter concentration of the dispersed solution was 12 wt %. Then, the dispersed solution was applied onto the rear surface (opposite to the surface of the ink-receiving layer) of recording medium 2 obtained in Example 1 by means of a dye coater to at a coating amount of 18 g/m² as determined after drying. Then, the applied solution was dried to obtain recording medium 4 having a back coat layer.

The recording medium 4 was practically stable without being curled after it had been left in an environment of a temperature of 30° C. and a relative humidity of 80%. The surface of the back coat layer containing γ-alumina could be used for printing characters.

### EXAMPLE 4

The recording medium 4 obtained in Example 3 was cut in pieces with dimensions of 100 mm×148 mm, which were as large as post cards. A photographic image was printed on the glossy surface of the ink-receiving layer of each of the post cards by means of an ink-jet printer (BJF-8500: tradename, available from Canon) according to the image information applied thereto and an address was printed on the back coat layer opposite to the ink-receiving layer. The printed image formed on the glossy surface was comparable to a silver salt photograph in terms texture and image quality, while the address printed on the rear surface was clearly readable because the printed characters were not bleeding at all. Thus, the post cards worked quite well.

The gloss of the image forming surface of a recording medium according to the invention is not less than 20% as measured at 20° so that the image printed thereon by means of an ink-jet recording system is comparable to a silver salt photograph in terms of texture and image quality. While the ink-receiving layer of a recording medium according to the invention shows an improved surface strength and is highly glossy, it is porous so that problems such as the blocking phenomenon and finger prints do not occur on the surface, and hence the recording medium can carry an excellent and stable image that can be stored for a long time without any damage.

What is claimed is:

1. A recording medium comprising a base material and an ink-receiving layer provided on said base material and containing a particulate material;
said particulate material containing particles of crystalline aluminum oxide;
said ink-receiving layer being obtained by applying a coating solution containing said particulate material to said base material followed by drying to form a coating layer, applying water to the coating layer to cause swelling and pressing the surface thereof against a heated mirror-surface drum to conduct drying treatment;
wherein the specular gloss of the surface of said ink-receiving layer is not less than 20% as measured at 20°.

2. A recording medium according to claim 1, wherein said particulate material contains particulate aluminum oxide by not less than 70 wt %.

3. A recording medium according to claim 1, wherein said particulate material contains particulate aluminum oxide by not less than 90 wt %.

4. A recording medium according to claim 1, wherein said ink-receiving layer contains a binder and the mixing ratio of said particulate aluminum oxide to said binder is within a range of between 5:1 and 25:1 by weight.

5. A recording medium according to claim 1, wherein the average particle diameter of said aluminum oxide particles is not more than 0.3 μm and not less than 80% of the total aluminum oxide particles has a particle diameter of not more than 1.0 μm.

6. A recording medium according to claim 1, wherein the BET specific surface area of the aluminum oxide is between 100 and 160 m²/g.

7. A recording medium according to claim 1, wherein said base material comprises a fibrous substrate and a surface layer containing barium sulfate provided on the fibrous substrate and said ink-receiving layer is provided on said surface layer.

8. A recording medium according to claim 7, wherein said fibrous substrate weighs 150 to 180 g/m².

9. A recording medium according to claim 7 or 8, wherein the Stoeckgt sizing degree of said fibrous substrate is not less than 200 seconds.

10. A recording medium according to claim 1, further comprising an alumina-containing layer provided on the surface of said base material opposite to the surface onto which said ink-receiving layer is provided.

11. An image-forming method of forming an image by applying a recording liquid to the surface of the ink-receiving layer of the recording medium according to claim 1 in response to recording information.

12. An image-forming method according to claim 11, wherein said application of the recording liquid is performed by means of an ink-jet recording system.

13. A method of manufacturing a recording medium comprising a base material and an ink-receiving layer provided on said base material and containing a particulate material, comprising:
producing a coating layer by applying a coating solution containing said particulate material containing particles of crystalline aluminum oxide to said base material followed by drying;
applying water to the coating layer to cause swelling and
pressing the surface of the swelled coating layer against a heated mirror-surface drum to produce said ink-receiving so as to have a specular gloss of the surface thereof not less than 20% as measured at 20°.

14. A manufacturing method according to claim 13, wherein said particulate material contains particulate aluminum oxide by not less than 70 wt %.

15. A manufacturing method according to claim 13, wherein said particulate material contains particulate aluminum oxide by not less than 90 wt %.

16. A manufacturing method according to claim 13, wherein said ink-receiving layer contains a binder and the mixing ratio of said particulate aluminum oxide to said binder is within a range of between 5:1 and 25:1 by weight.

17. A manufacturing method according to claim 13, wherein the average particle diameter of said aluminum oxide particles is not more than 0.3 μm and not less than 80% of the total aluminum oxide particles has a particle diameter of not more than 1.0 μm.

18. A manufacturing method according to claim 13, wherein the BET specific surface area of the aluminum oxide is between 100 and 160 m²/g.

19. A manufacturing method according to claim 13, wherein said base material comprises a fibrous substrate and a surface layer containing barium sulfate provided on the fibrous substrate and said ink-receiving layer is provided on said surface layer.

20. A manufacturing method according to claim 19, wherein said fibrous substrate weighs 150 to 180 g/m².

21. A manufacturing method according to claim 19 or 20, wherein the Stoeckgt sizing degree of said fibrous substrate is not less than 200 seconds.

22. A manufacturing method according to claim 13, further comprising: a step of providing an alumina-containing layer on the surface of said base material opposite to the surface onto which said ink-receiving layer is provided.
